(19) United States
(12) Patent Application Publication
(10) Pub. No.: US 2018/0260805 A1
(43) Pub. Date: Sep. 13, 2018

(54) APPARATUS FOR ENABLING FIGURINE FOR EFFECTING A TRANSACTION

(71) Applicant: MASTERCARD ASIA/PACIFIC PTE. LTD., Singapore (SG)

(72) Inventors: Ai Ling Felicia Choo, Singapore (SG); Benjamin Charles Gilbey, Singapore (SG); Vijin Venugopalan, Singapore (SG)

(21) Appl. No.: 15/917,356

(22) Filed: Mar. 9, 2018

(30) Foreign Application Priority Data
Mar. 10, 2017 (SG) 10201701979Y

(51) Int. Cl. G06Q 20/32; G06Q 20/40; G06Q 20/36; G06Q 20/38

(52) U.S. Cl. CPC G06Q 20/3223; G06Q 20/382; G06Q 20/367; G06Q 20/401

(57) ABSTRACT

An apparatus for enabling a figurine for effecting a transaction is provided. The apparatus includes at least one processor, and at least one memory including computer program code. The at least one memory and the computer program code is configured to, with the at least one processor, cause the apparatus at least to receive a figurine identifier identifying the figurine, receive account information relating to an account to be linked to the figurine, retrieve authentication information corresponding to the account based on the account information, link the figurine to the account by associating the figurine identifier with the authentication information.

### CROSS-REFERENCE TO RELATED APPLICATION

This application is a U.S. National Stage filing under 35 U.S.C. § 119, based on and claiming benefits of and priority to Singapore Patent Application No. 10201701979Y filed on Mar. 10, 2017. The entire disclosure of the above application is incorporated herein by reference.

### FIELD OF INVENTION

The present invention relates broadly, but not exclusively, to apparatuses and methods for enabling a figurine for effecting a transaction.

### BACKGROUND

Over the last few decades, it has become common for individuals to own several payment cards, such as debit cards and credit cards, and to choose from among them depending on the situation.

It is also common to provision several payment cards into a digital wallet, in which a user retains information about payment cards, loyalty accounts and other personal details such as addresses.

In general, physical payment cards lack variety since they are required to comply with shape and size constraints in order to reliably be accepted at point of sale terminals and automated teller machines. It would be desirable to provide an alternative form of payment device which is not subject to such constraints.

### SUMMARY

According to a first aspect of the present invention, an apparatus for enabling a figurine for effecting a transaction is provided. The apparatus includes at least one processor, and at least one memory including computer program code. The at least one memory and the computer program code is configured to, with the at least one processor, cause the apparatus at least to receive a figurine identifier identifying the figurine, receive account information relating to an account to be linked to the figurine, retrieve authentication information corresponding to the account based on the account information, link the figurine to the account by associating the figurine identifier with the authentication information.

According to a second aspect of the present invention, a computer-implemented method enabling a figurine for effecting a transaction is provided. The computer-implemented method includes receiving a figurine identifier identifying the figurine, receiving account information relating to an account to be linked to the figurine, retrieving authentication information corresponding to the account based on the account information, linking the figurine to the account by associating the figurine identifier with the authentication information.

According to a third aspect of the present invention, a computer readable medium for enabling a figurine for effecting a transaction is provided. The computer readable medium contains a program for causing a computer at least to receive a figurine identifier identifying the figurine, receive account information relating to an account to be linked to the figurine, retrieve authentication information corresponding to the account based on the account information, link the figurine to the account by associating the figurine identifier with the authentication information.

Unless context dictates otherwise, the following terms will be given the meaning provided here:
“figurine” means a three dimensional figure, including collectibles, icons/three dimensional representation of cartoon characters, heroes/heroines, and other fictional or non-fictional beings such as animals, celebrities and sportsmen/sportswomen;
“figurine identifier” refers to an identifier specific to each figurine. In one example, the identifier can have length between 16 to 20 digits. In general, the figurine identifier is shown on a surface of the figurine and a user can see the figurine identifier.
“account” refers to a payment card or a digital wallet. A payment card is a card that can be used by an account holder for a transaction with a merchant. In the following description, the term “payment cards” refer to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers. Each type of payment card can be used as a method of payment for performing a transaction. In the following description, a digital wallet is an account that can be used by a digital wallet user for a transaction with a merchant. The digital wallet is usually linked to a digital wallet user's bank account or a digital wallet user's payment card. Typically, the payments by digital wallets are facilitated by a different entity such as Google®, Apple® or Paypal®. Additionally or alternatively, the payments by digital wallets are facilitated by an entity who also managed the payment cards such as MasterCard®;
“account holder” refers to either a payment card user or a digital wallet user. In specific embodiments, the payment card user may also be a digital wallet user. For example, a payment card user may register his payment card to a digital wallet account which qualifies the payment card user as a digital wallet user.
“customer” refers to a party who initiates a transaction with a merchant. In one example, the customer may initiate the transaction with the merchant to buy goods and/or services from the merchant using his payment card.
“Effecting a transaction” involves a payment between parties to the transaction. Effecting a transaction may also be known as conducting a transaction.
“account information” refers to data identifying the account indicated to be used or any information necessary to effect a transaction. For a credit card, for example, the account information may include a credit card number, account number, card or account balance, expiry date and so forth. That is, the account data may include the name of the account holder, the primary account number (or “PAN”) and the date of expiry of the account (if applicable). PAN refers to a number of digits (or characters) which identify an account issued by an issuer (for example, a bank). For example, in some embodiments an account (e.g. credit account, debit account, pre-paid account) is issued by an issuer pursuant to the MasterCard® International Incorporated rules, and the PAN may be a thirteen to nineteen-digit string that identifies both the issuer (e.g. which may be based on the first few digits of the string, for example, the first five to ten digits) and the specific account (e.g. which may be based on some or all of the remaining digits).
The PAN may also identify if the holder is subscribed to a standardized Internet transaction protocol such as the 3-D Secure™ Network. In an embodiment, the 3-D Secure™ Network service may underlie the authentication programs offered by payment networks (e.g. SecureCode™ by MasterCard®) to authenticate a client for a merchant during an eCommerce transaction. The PAN is typically utilized to route and process transactions that involve the account. Those skilled in the art will appreciate that other primary account schemes and formats may be used in conjunction with embodiments described herein.
“figurine token” refers to a token of a figurine and functions like a PAN. In an example it is a 16 digit Token (surrogate PAN) which is preloaded on a figurine. That is, PAN refers to a number of digits (or characters) which identify an account issued by an issuer (for example, a bank). For example, in some embodiments an account (e.g. credit account, debit account, pre-paid account) is issued by an issuer pursuant to the MasterCard® International Incorporated rules, and the token may be a thirteen to nineteen-digit string that identifies both the issuer (e.g. which may be based on the first few digits of the string, for example, the first five to ten digits) and the specific account (e.g. which may be based on some or all of the remaining digits). The token may also identify if the holder is subscribed to a standardized Internet transaction protocol such as the 3-D Secure™ Network. In an embodiment, the 3-D Secure™ Network service may underlie the authentication programs offered by payment networks (e.g. SecureCode™ by MasterCard®) to authenticate a client for a merchant during an eCommerce transaction. The token is typically utilized to route and process transactions that involve the account. Those skilled in the art will appreciate that other primary account schemes and formats may be used in conjunction with embodiments described herein. In general, the figurine token cannot be seen by a user or a merchant.
“authentication information” refers to any information which authenticate an account to be used for transactions. In one example, the authentication information is a key for use in transaction in accordance with EMV standard.
“transaction” refers to any financial related transaction from an account. In general, it refers to a payment transaction at a merchant to purchase a product or a service.
“verification information” refers to any information which verify a user to be an owner of the account. In one example, the verification information is a PIN code sent to a pre-registered telephone number via SMS so that an owner of the account can submit for the verification.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a block diagram of a transaction system within which a figurine may be enabled for effecting transactions according to some embodiments;

FIG. 2 shows a schematic view of a figurine according to some embodiments;

FIG. 3 is a flowchart of a method for enabling a figurine for effecting transactions according to some embodiments;

FIG. 4 shows a user holding a figurine according to some embodiments;

FIG. 5 shows an exemplary flow of a method for enabling a figurine for effecting transactions according to some embodiments;

FIG. 6 shows an exemplary computing device suitable for executing the method for enabling a figurine for effecting transactions according to some embodiments; and

FIG. 7 is a schematic view of a payment networking server in FIG. 1 according to some embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “retrieving”, “linking”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

The present embodiments relate to an apparatus for enabling a figurine for effecting a transaction. By enabling the figurine for effecting a transaction from an account, a user can use the figurine for payment transaction from an account. Accordingly, options other than physical credit cards or a digital wallet are available for the user to effect transaction from an account. Also, it is advantageously clear for a user to distinguish one figurine from the other figurine.

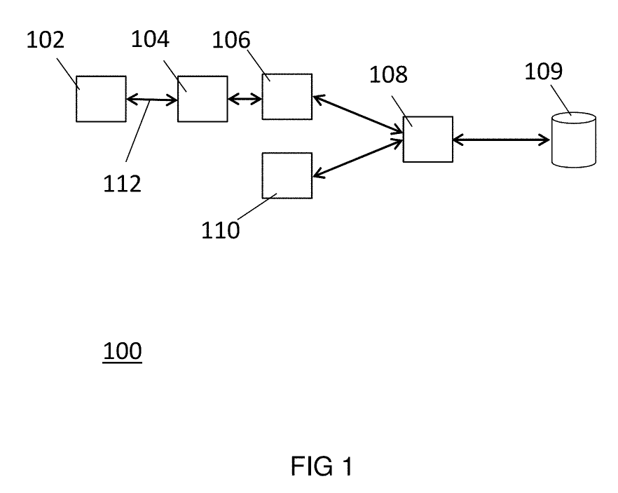

FIG. 1 is a block diagram of a transaction system within which a figurine may be enabled for effecting transactions according to some embodiments.

The system 100 comprises a transaction device 102 in communication with a merchant device 104. The transaction device 102 may also be in direct communication with a payment network server 108, without having to communicate with the merchant device 104.

The merchant device 104 is in communication with an acquirer server 106. The acquirer server 106, in turn, is in communication with the payment network server 108 and the wallet-based network server 114 (not shown). The payment network server 108, in turn, is in communication with an issuer server 110.

Use of the term ‘server’ herein can mean a single computing device or a plurality of interconnected computing devices which operate together to perform a particular function. That is, the server may be contained within a single hardware unit or be distributed among several or many different hardware units.

The transaction device 102 typically is associated with a customer (or user) who is a party to a transaction that occurs between the transaction device 102 and the merchant device 104 through a transaction. For embodiments described below, the transaction device 102 is a figurine which relates to a three dimensional figure, including collectibles, icons of cartoon characters, icons of heroes/heroines

The merchant device 104 typically is associated with the merchant who is also a party to the transaction that occurs between transaction device 102 and the merchant device 104 through the transaction. The merchant device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

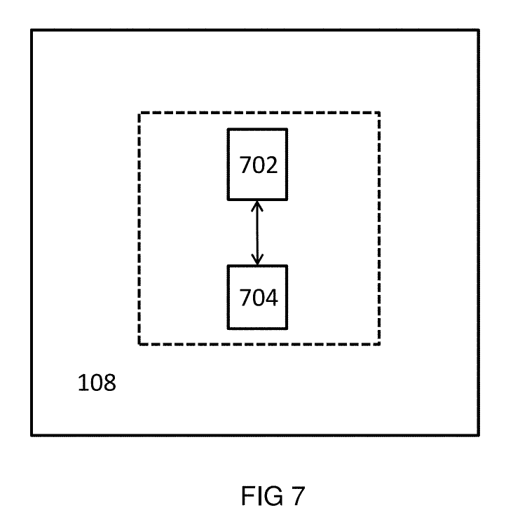

The payment network server 108 typically is associated with a payment facilitator. For example, the payment network server 108 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions. An exemplary payment network server 108 is shown in FIG. 7.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of transaction devices 102.

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered are included in the database 109. In other embodiments, the payment network server 108 may also be configured to communicate with, or may include, another database 140 (not shown). The database 140 may include data corresponding to a payment card user. Examples of the data include name, age group, income group, address, gender or the like relating to the payment card user.

The transaction device 102 is capable of wireless communication using a suitable protocol with the merchant device 104. For example, embodiments may be implemented using transaction devices 102 that are capable of communicating with WiFi/Bluetooth-enabled merchant devices 104. It will be appreciated by a person skilled in the art that depending on the wireless communication protocol used, appropriate handshaking procedures may need to be carried out to establish communication between the transaction device 102 and the merchant device 104. For example, in the case of Bluetooth communication, discovery and pairing of the transaction device 102 and the merchant device 104 may be carried out to establish communication.

In an example, during a transaction, a transaction request message 112 is generated at the transaction device 102. The transaction request message 112 is generated by the transaction device 102 in response to the customer (or payment card user) making a selection of a good and/or service to be purchased from the merchant. In other words, the transaction request message 112 relates to a transaction between the payment card user and the merchant. The transaction may be performed via a website of the merchant. In specific implementations, transaction device 102 may be fitted with a wireless communications interface such as a Near Field Communication (NFC) interface to enable the transaction device 102 to electronically communicate with the merchant device 104 to perform the transaction. NFC is a set of standards to establish radio communication between devices by bringing them into close proximity such as only a few centimetres. NFC standards cover communication protocols and data exchange formats, and are based on radio-frequency identification (RFID) technology.

Each transaction data relates to a transaction and identifies the figurine and the merchant, generally by way of identifiers of each associated with the payment card user and merchant respectively. Further, the transaction data may also identify the good and/or service to be purchased and a type or nature of the transaction. The transaction data may further identify a value or price of the good and/or service (e.g., a transaction amount) and a location where the good and/or service will be delivered. The transaction data may also indicate a time and date at which the transaction was initiated by the payment card user.

The process described above involves multiple parties (e.g., figurine holder, merchant, acquirer, issuer, payment facilitator). However, the process may be essentially viewed as a transaction between a figurine holder (or a user) and a merchant (with the other parties facilitating the transaction).

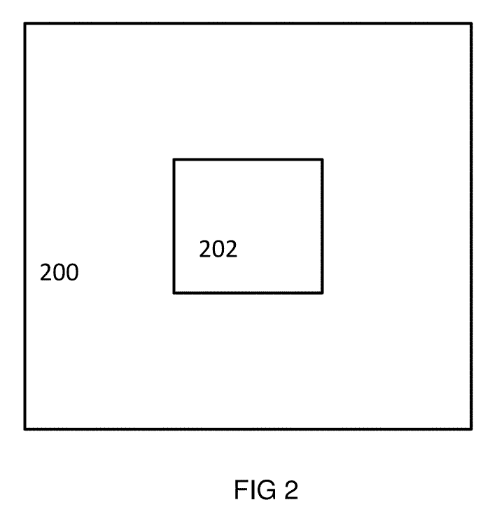

FIG. 2 shows a schematic view of a figurine 200 according to some embodiments. The figurine 200 may be a three dimensional collectibles, icons of cartoon characters or icons of heroes. The figurine 200 may be animals, plants, 3D or scanned people. The figurine 200 may be made of metal, plastic, wood and the figurine 200 may be manufactured by 3D printer or moulding. The figurine 200 may be a key holder or strap for mobile phone.

The figurine 200 may include a processing device 202. The processing device 202 may be embedded in the figurine 200. Alternatively, the processing device 202 may be attached to the figurine 200 and the processing device 202 is removable. The processing device 202 may include a memory and a wireless communication module. The processing device 202 may be an EMV chip, which comply with a technical standard for smart payment cards and for payment terminals and for payment terminals.

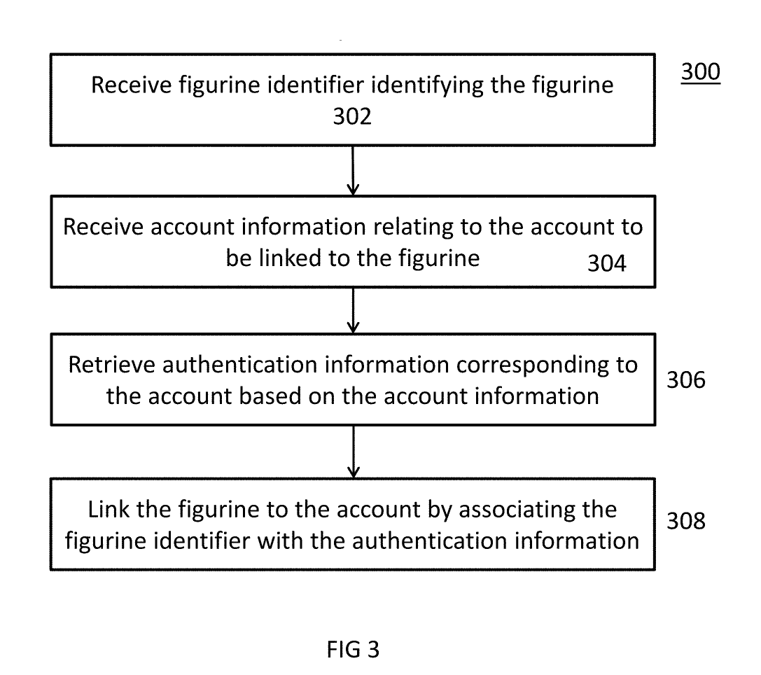

FIG. 3 is a flowchart of a method 300 for enabling a figurine for effecting transactions according to some embodiments. The method 300 broadly comprises:
Step 302: receiving figurine identifier identifying the figurine;
Step 304: receiving account information relating to the account to be linked to the figurine;
Step 306: retrieving authentication information corresponding to the account based on the account information; and
Step 308: linking the figurine to the account by associating the figurine identifier with the authentication information.

The method 300 comprises a step 302 of receiving figurine identifier identifying the figurine. Step 302 may include operationally communicating with a server to receive the figurine identifier. In one example, the server is a web server and the figurine identifier is received via the web server. The figurine identifier may be shown on the figurine and the figurine identifier is input on a website or a mobile app on a server and received via the server.

The method 300 further comprises a step 304 of receiving account information relating to the account to be linked to the figurine. Step 304 may include operationally communicating with a server to receive the account information. In one example, the server is a web server and the account information is received via the web server. The account information may be input on a website or a mobile app on a server and received via the server. Alternatively, the account information may be stored in a mobile app of an issuer bank and received via the mobile app.

The method 300 further comprises a step 306 of retrieving authentication information corresponding to the account based on the account information. In an example, the account information received in step 304 is forwarded to an issuer of the account. The account information is checked by the issuer of the account and authentication information corresponding to the account is retrieved based on the account information.

The method 300 further comprises a step 308 of linking the figurine to the account by associating the figurine identifier with the authentication information. In one example, the figurine identifier and the authentication information are associated in a database so that one of them can be retrieved by the information of the other. The authentication information may be a key for use in EMV transaction. With the authentication information, signature or 4 or 6 digits PIN code are not required at the time of payment transaction.

In an example, the method 300 further comprises a step of determining if the account is one that is subscribed to a service based on the account information. The service is one that allows the account to be linked to a figurine. For example, a user of the account subscribes a service provided by the issuer of the account. The service allows a subscriber of the service to use a figurine for payment transaction as if the figurine is a credit card issued by the issuer after registration.

In one example, a request message requesting for the figurine to be enabled is received and the determination if the account is one that is subscribed to a service based on the account information is performed in response to the receipt of the request message. The request message may be received together with the figurine identifier and/or the account information. In one example, the method further comprises a step of operationally communicating with a server to receive the request message.

Furthermore, the method may further comprise a step of requesting verification information in response to the receipt of the request message. The verification information is configured to verify if request message is sent from an owner of the account. In an example, the authentication information retrieved in step 306 can be used as the verification information.

The method may further comprise a step of receiving the verification information and verifying the verification information by comparing the verification information with the authentication information corresponding to the account. Once the account is verified as the subscriber of the service, the account is linked to the figurine as requested by the user of the account. In one example, the user may choose one of several figurines offered by the provider of the service, e.g. the issuer of the account. In the other example, the user may obtain a figurine to be linked to the account from a third party.

The method may further comprise a step of updating a database that the figurine is linked to the account. Even if the user were to lose the figurine linked to the account, the user is able to cut the linkage between the figurine and the account to avoid unauthorized use. If the user obtains a new figurine, the user is able to replace the old figurine with the new figurine by updating the database that the new figurine is now linked to the account. If the user obtains a new account, the user is able to replace the old account with the new account by updating the database that the figurine is now linked to the new account. It is also possible to activate or deactivate the figurine by updating information in the database. An exemplary table in the database is shown in Table 1.

TABLE 1
Mapping between Figurine and Account

| Figurine | | Account | | Figurine |
|---|---|---|---|---|
| identifier | Figurine Token | information | Figurine status | transaction |
| AB123456 | 512XXXX | 523XXXX | Active | |
| BC234567 | 531XXXX | 542XXXX | Deleted | |

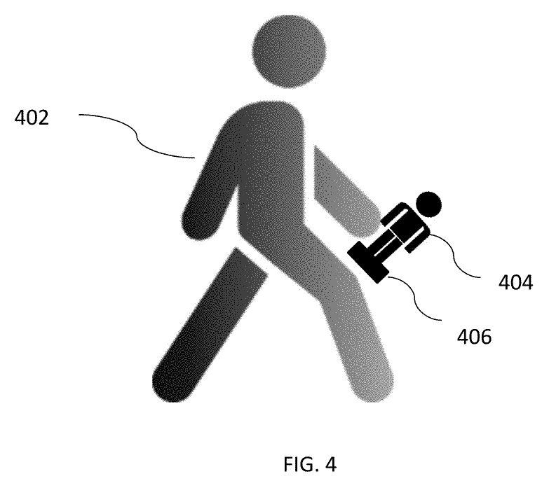

FIG. 4 shows a user holding a figurine according to some embodiments. In an example, a user 402 holds a figurine 404. In an example, a processing device 406 is attached integrally or separately to the figurine 404 as a base of the figurine as shown in FIG. 4. The processing device 406 may be embedded in the figurine 404. The figurine 404 may be of a handy size and configured to be used at a casher for payment transaction.

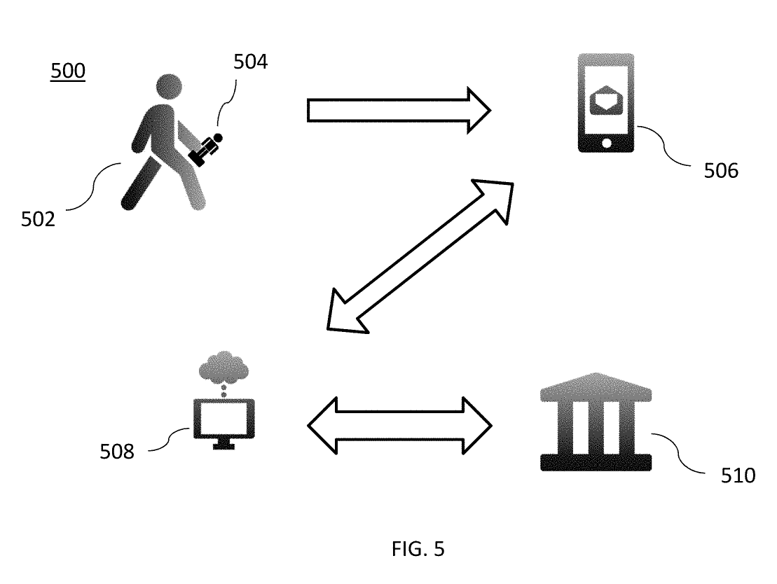

FIG. 5 shows an exemplary flow 500 of a method for enabling a figurine for effecting transactions according to some embodiments. In an example, a user 502 obtains a figurine 504 from a third party merchant. The figurine 504 includes a processing device; however, no account has not been linked to the figurine 504 yet. If the figurine 504 is obtained from a second hand market, an account of a previous user of the figurine may still be linked to the figurine 504.

In an example, the figurine 504 can be registered via smart phone 506. The user 502 sees a figurine identifier on a figurine 504 and input the figurine identifier on a mobile app in the smart phone 506. The user 502 also inputs the account information of the account to be linked with the figurine 504 via the mobile app in the smart phone 506. The smart phone 506 forwards the figurine identifier and the account information to an apparatus 508.

The apparatus 508 retrieve authentication information for the account from an issuer 510 of the account based on the account information. After retrieving the authentication information for the account, the apparatus links the account and the figurine by associating the account information and authentication information with the figurine identifier. In one example, a figurine token is retrieved from one or more database based on the figurine identifier and the figurine token is associated with the account information and the authentication information. Once the linkage between the account and the figurine is established, the issuer 510 is notified about the establishment of the linkage between the account and the figurine.

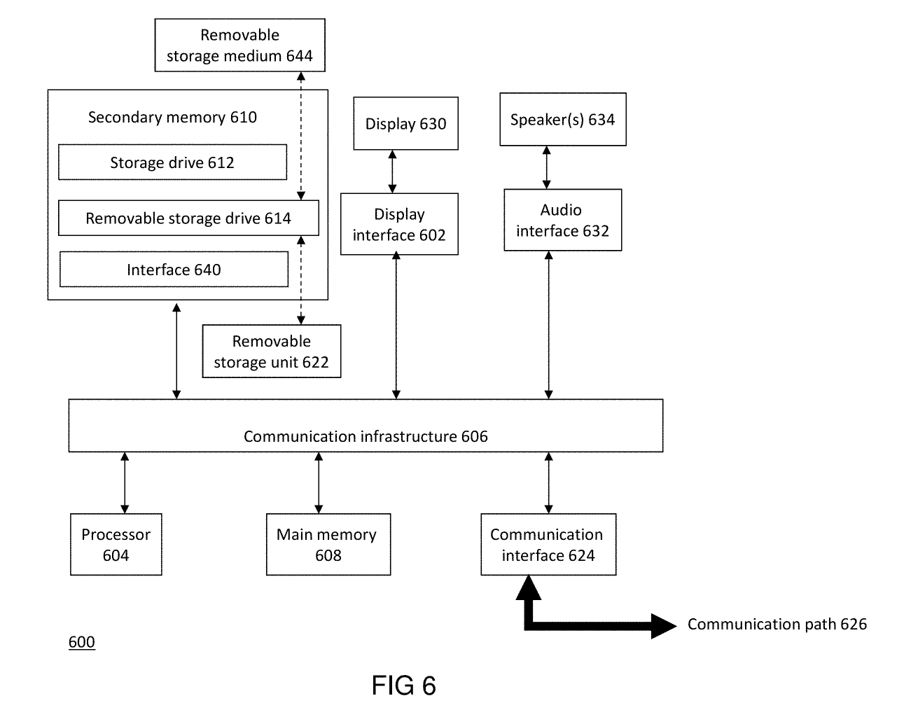

FIG. 6 depicts an exemplary computer/computing device 600, hereinafter interchangeably referred to as a computer system 600, where one or more such computing devices 600 may be used to facilitate execution of the above-described method for enabling a figurine for effecting a transaction. In addition, one or more components of the computer system 600 may be used to realize the computer 100. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 644 in a well-known manner. The removable storage medium 644 may include magnetic tape, optical disk, non-volatile memory storage medium, or the like, which is read by and written to by removable storage drive 614. As will be appreciated by persons skilled in the relevant art(s), the removable storage medium 644 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 640. Examples of a removable storage unit 622 and interface 640 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 640 which allow software and data to be transferred from the removable storage unit 622 to the computer system 600.

The computing device 600 also includes at least one communication interface 724. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port (such as a serial, parallel, printer, GPIB, IEEE 1393, RJ35, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage medium 644, removable storage unit 622, a hard disk installed in storage drive 612, or a carrier wave carrying software over communication path 626 (wireless link or cable) to communication interface 624. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 640. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 100 may be combined together. Additionally, in some embodiments, one or more features of the computing device 600 may be split into one or more component parts.

In an implementation, the payment network server 108 may be generally described as an apparatus comprising at least one processor 702 and at least one memory 704 including computer program code. The at least one memory 704 and the computer program code are configured to, with the at least one processor 702, cause the apparatus to perform the operations described in FIG. 3. An example of the payment network server 108 is shown in FIG. 7.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An apparatus for enabling a figurine for effecting a transaction, the apparatus comprising:
at least one processor; and
at least one memory including computer program code;
the at least one memory and the computer program code configured to, with the at least one processor, cause the apparatus at least to:
receive a figurine identifier identifying the figurine;
receive account information relating to an account to be linked to the figurine;
retrieve authentication information corresponding to the account based on the account information; and
link the figurine to the account by associating the figurine identifier with the authentication information.

2. The apparatus in accordance with claim 1, wherein the at least one memory and the computer program code are configured to, with the at least one processor, further cause the apparatus to:
retrieve a figurine token corresponding to the figurine based on the figurine identifier, the figurine token identifying a type of transaction that the figurine is configured to conduct; and
link the figurine to the account by associating the figurine token with the authentication information.

3. The apparatus in accordance with claim 1, wherein the at least one memory and the computer program code are configured to, with the at least one processor, further cause the apparatus to:
operationally communicate with a server to receive the figurine identifier.

4. The apparatus in accordance with claim 1, wherein the at least one memory and the computer program code are configured to, with the at least one processor, further cause the apparatus to:
operationally communicate with a server to receive the account information.

5. The apparatus in accordance with claim 1, wherein the at least one memory and the computer program code are configured to, with the at least one processor, further cause the apparatus to:
determine whether the account is one that is subscribed to a service based on the account information, the service being one that allows the account to be linked to a figurine.

6. The apparatus in accordance with claim 5, wherein the at least one memory and the computer program code are configured to, with the at least one processor, further cause the apparatus to:
receive a request message requesting for the figurine to be enabled, and
in response to the receipt of the request message, perform the determination of whether the account is one that is subscribed to the service.

7. The apparatus in accordance with claim 6, wherein the at least one memory and the computer program code are configured to, with the at least one processor, further cause the apparatus to:
request verification information in response to the receipt of the request message, the verification information verifying if the request message has been sent from an owner of the account.

8. The apparatus in accordance with claim 7, wherein the at least one memory and the computer program code are configured to, with the at least one processor, further cause the apparatus to:
receive the verification information, and
verify the verification information by comparing the verification information with a password registered to the account.

9. The apparatus in accordance with claim 1, wherein the at least one memory and the computer program code are configured to, with the at least one processor, further cause the apparatus to:
update a user database to indicate that the figurine is linked to the account.

10. A computer-implemented method for enabling a figurine for effecting a transaction, the method comprising:
receiving a figurine identifier identifying the figurine;
receiving account information relating to an account to be linked to the figurine;
retrieving authentication information corresponding to the account based on the account information; and
linking the figurine to the account by associating the figurine identifier with the authentication information.

11. The computer-implemented method in accordance with claim 10, further comprising:
retrieving a figurine token corresponding to the figurine based on the figurine identifier, the figurine token identifying a type of transaction that the figurine is configured to conduct; and
linking the figurine to the account by associating the figurine token with the authentication information.

12. The computer-implemented method in accordance with claim 10, further comprising operationally communicating with a server to receive the figurine identifier.

13. The computer-implemented method in accordance with claim 10, further comprising:
operationally communicating with a server to receive the account information.

14. The computer-implemented method in accordance with claim 10, further comprising:
determining whether the account is one that is subscribed to a service based on the account information, the service being one that allows the account to be linked to a figurine.

15. The computer-implemented method in accordance with claim 14, further comprising:
receiving a request message requesting for the figurine to be enabled, and
in response to the receipt of the request message, performing the step of determining whether the account is one that is subscribed to the service.

16. The computer-implemented method in accordance with claim 15, further comprising:
requesting verification information in response to the receipt of the request message, the verification information verifying if the request message is sent from an owner of the account.

17. The computer-implemented method in accordance with claim 16, further comprising:
receiving the verification information, and
verifying the verification information by comparing the verification information with a password that is registered to the account.

18. The computer-implemented method in accordance with claim 10, further comprising:
updating a database to indicate that the figurine is linked to the account.

19. A computer readable medium for enabling a figurine for effecting a transaction, containing a program for causing at least one processor to execute at least the steps of:
receiving a figurine identifier identifying the figurine;
receiving account information relating to an account to be linked to the figurine;
retrieving authentication information corresponding to the account based on the account information; and
linking the figurine to the account by associating the figurine identifier with the authentication information.
